(19) United States
(12) Patent Application Publication
(10) Pub. No.: US 2013/0232440 A1
(43) Pub. Date: Sep. 5, 2013

(54) SYSTEM AND METHOD FOR GENERATING A USER INTERFACE BY AUCTIONING SPACE ON THE USER INTERFACE TO SELF-DETERMINING, CONTENT-PROVIDING MODULES

(71) Applicant: CLOUDMADE, INC., Menlo Park, CA (US)

(72) Inventors: James Brown, Flitton (GB); Nick Black, San Francisco, CA (US)

(73) Assignee: CloudMade, Inc., Menlo Park, CA (US)

(21) Appl. No.: 13/830,314

(22) Filed: Mar. 14, 2013

Related U.S. Application Data
(63) Continuation-in-part of application No. 13/410,290, filed on Mar. 1, 2012.

(51) Int. Cl. G06F 3/0484

(52) U.S. Cl. CPC G06F 3/0484
USPC 715/781

(57) ABSTRACT

A system and method is provided for generating a dynamic, user interface that is capable of frequently changing and learning to provide the most relevant information to the user. The method includes executing a plurality of user interface (UI) modules on a computing device. Each UI module is a software component that provides content for display in the user interface. Each UI module determines its own content and its own priority level and bids for user interface space using its determined priority level. A UI controller is executed on the computing device. The UI controller is a software component that receives bids for the UI modules, determines the number of available spots for UI modules in the user interface, and selects UI modules associated with the highest priority for display in the available user interface spots.

### CROSS-REFERENCE TO RELATED APPLICATIONS

The current application is a continuation-in-part of and claims priority to U.S. patent application Ser. No. 13/410,290, titled “SYSTEM AND METHOD FOR GENERATING A USER INTERFACE BY AUCTIONING SPACE ON THE USER INTERFACE TO SELF-DETERMINING, CONTENT-PROVIDING MODULES” filed Mar. 1, 2012, the disclosure of which is incorporated herein by reference.

### BACKGROUND OF THE INVENTION

1. Field of the Invention

This invention relates generally to user interfaces and, more particularly, to a system and method for selecting content for a user interface.

2. Description of the Background Art

As people are increasingly using mobile phones, navigation devices, tablets, and other computing devices, there is a need for user interfaces on such devices that can dynamically provide a user with a variety of up-to-date information relevant to the user. For example, at present, navigation devices offer a user the benefit of directing him or her to his or her intended destination, as well as basic Internet search capabilities for finding local attractions and related general information. While this level of functionality is, without a doubt, useful to the user, as more and more computing devices are being brought into the realm of greater interactivity, users will soon expect to have more information at their fingertips, which is tailored to them and specific to their interest.

For example, a user may not just want to know where the local gas stations are located, but will want to know which gas stations along their route are in a price range that they would consider stopping at. This requires the system to know or learn the user's behavior. The user may want to know where his or her friends are located and the local venues they are currently visiting. The user may want to know which local venues are hosting events or offering specials on products or services related to his or her interests.

Known user interfaces on navigation devices, mobile phones, and other computing device are typically not designed to provide the user with a plurality of information that frequently changes based on the user's likely interest and context (e.g., location, whether driving, etc.). One of the challenges of providing such an interface is determining what content to display on the interface at any time. Traditional interface generation software uses a centralized process to determine what to display on the interface at any given time.

### SUMMARY OF THE INVENTION

Embodiments in accordance with the present invention are disclosed that provide a system and method for generating a user interface for user device by auctioning space on the interface to a plurality of self-determining UI modules. In accordance with embodiments of this invention, a user interface (UI) include regions for displaying content on a computing device. The UI also includes UI modules being executed by the computing device that select content for display within a region of the user interface and a UI controller being executed by the computer device that selects at least one UI module to provide content for display within each of the regions in the UI.

The process for selecting the UI displayed is performed in the following manner in accordance with embodiments of this invention. Information for different categories of content is received by the computing device. The categories are then using each of the UI modules. Each IU module then selects a category to display and determines its priority level. Each UI module then transmits a bid to the UI controller that includes the priority level of the UI module.

The UI controller receives the bids from each of the UI modules and uses the priority levels of the UI modules to assign at least one UI module to display content in each of the regions of the user interface based on the priority levels of the UI modules.

### BRIEF DESCRIPTION OF THE DRAWINGS

FIG. 1 is a flowchart that illustrates a general method for determining content for a user interface in accordance with an embodiment of this invention.

FIG. 2 is a flowchart that illustrates the operation of the user interface (UI) modules in accordance with an embodiment of this invention.

FIG. 3 is a flowchart that illustrates the operation of the UI controller in accordance with an embodiment of this invention.

FIG. 4 is a diagram that illustrates software architecture of devices in accordance with an embodiment of this invention.

FIGS. 5A and 5B illustrate implementations of the user interface in a “Dashboard Mode” in accordance with embodiments of this invention.

FIG. 6 illustrates another implementation of the user interface in a “Driving Mode” on a navigation device in accordance with an embodiment of this invention.

FIG. 7 is a flowchart that illustrates how a “Gas Price” UI module operates in accordance with an embodiment of this invention.

FIG. 8 illustrates another implementation of the user interface in a “Friends Mode” on a navigation device in accordance with an embodiment of this invention.

FIG. 9 is flow diagram that illustrates a process performed by a UI module for ranking categories of content in a UI module in accordance with embodiments of this invention.

FIG. 10 is a flow diagram that illustrates a process performed by a UI module for determining a priority level based on the display category in accordance with embodiments of this invention.

FIG. 11 is a flow diagram that illustrates a process performed by the UI controller to modify the priority level of a UI module received in a bid in accordance with embodiments of this invention.

FIG. 12 is a flow diagram that illustrates a process performed by the UI controller to provide a flipping animation when information displayed in an interface of a UI module is updated in accordance with an embodiment of this invention.

FIG. 13 is a block diagram of components in a client device that perform instructions that provide a system and method in accordance with embodiments of this invention.

### DETAILED DESCRIPTION

Turning now to the drawings, systems, software applications, and methods for generating a dynamic, user interface that is capable of frequently changing and learning to provide the most relevant information to the user in accordance with embodiments of this invention are described. Specifically, many embodiments of the invention provide a tailored, self-learning user interface (UI) system with (1) a plurality of UI modules, where each individual UI module is a software component that determines its own content and interest level to the user, and (2) a UI controller that determines the number of available spots on the user interface and selects UI modules for display in the interface based on the individual module's self-determined priority (i.e., interest level to the user) are described.

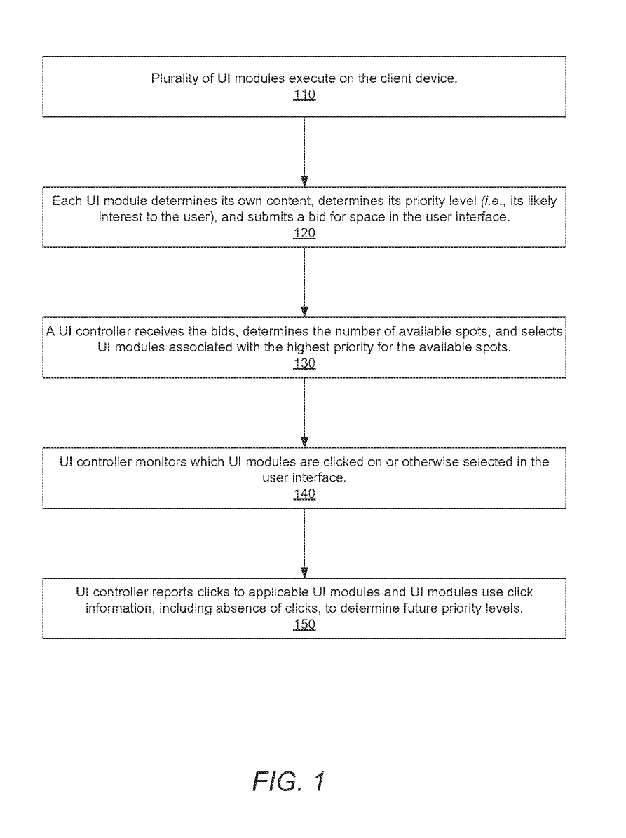

As seen in the method for display relevant information shown in FIG. 1, a plurality of UI modules is executed on the client device (110). The client device may be any computing device, such as a mobile phone (e.g., IPHONE, ANDROID phone, etc.), personal digital assistant, or a portable or in-dash navigation device.

Each UI module is a software component that provides displays of data content pertaining to a particular topic. A UI module determines its own content, determines its priority level (i.e., the contents likely interest to the user), and submits a bid with its priority level for space in the user interface (120). In other words, each UI module essentially acts as its own agent and bids for a spot on the user interface. Examples of possible UI modules include, modules that provide content related to topics such as gas prices, friends, events, deals, attractions along a route, eco-driving tips, a to do list, weather, traffic and road alerts, a drive list, and many more.

For example, a “Deals” module receives data for a number of categories having deals in a particular area. Based on the user's profile indicating that he or she loves chocolate and the user's prior history of visiting the Ghiradelli Ice Cream and Chocolate store, the UI module may rank the category with a Ghiradelli's deal as being higher than other categories that include data for other deals in the area and selects the category that includes the Ghiradelli's deal to display. But since the user sometimes stops off at Ghiradelli's when a deal is offered to him or her, but sometimes does not stop off, the UI module may determine the priority level or interest to the user is a medium priority level. The UI module then provides a bid for a space in the user interface with medium priority level to the UI controller. On the other hand, a “Weather” (UI) module may receive data in a category regarding a fast approaching hailstorm. The UI controller ranks this category more important than categories including other local weather information and selects the category with the hailstorm information to display. The “Weather” module then may determine that the data in the category with the hailstorm information is important to convey to the user and is of a high priority or interest to the user. The “Weather” module then submits a bid for a space in the user interface with a high priority level to the UI controller.

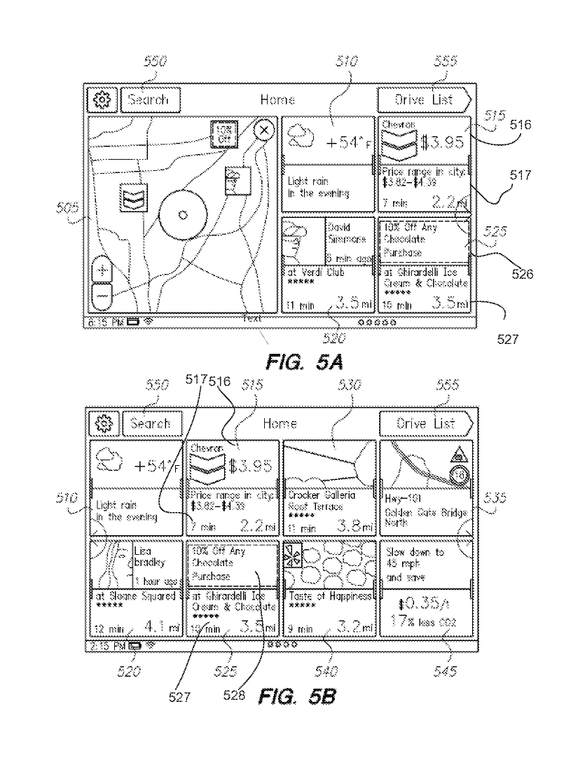

A UI controller receives bids, determines the number of available spots, and selects the UI modules associated with the highest priority for the available spots (130). The number of available spots is determined at least in part based on the mode of the user interface. FIG. 5A illustrates a user interface on a navigation device that is in a mode with a map plus four available spots (currently filled by UI modules 510, 515, 520, and 525). FIG. 5B illustrates a user interface on a navigation device that is in a mode that has six available spots (currently filled by UI modules 510, 515, 520, 530, 535, 540, 545). Once the number of available spots is determined, the controller then selects which UI modules are allotted a spot based on the modules self-determined priority levels.

In the accordance with some embodiments, a user “clicks” on or in some other way selects a display provided by a UI module to obtain more information about the category displayed by the UI module. The UI controller monitors which displays provided by UI modules are clicked on or otherwise selected in the user interface (140), as this provides valuable feedback on how interesting the user finds the content of the UI module. The UI controller will report the clicks or selections to the applicable UI modules. The UI modules use the selection information, including absence of clicks, to determine future rankings of categories and/or priority levels (150).

The importance of the selection information in determining category rankings and priority may vary among the UI modules. For example, a user may be interested in viewing the weather forecast, but may not be likely to click on or select the display provided by the Weather module to get details of the forecast. However, if a user is interested in nearby deals, the user is more likely to click on or select a display provided by a Deals module to learn more about the deals or to see other deals in an area. Therefore, the number of clicks or selections that the display of the Deals module receives may be more indicative of user interest in the Deals module than the number of clicks or selections the display of a Weather module receives. In such case, the Deals module would rely on click feedback more heavily than the Weather module in setting future priority levels.

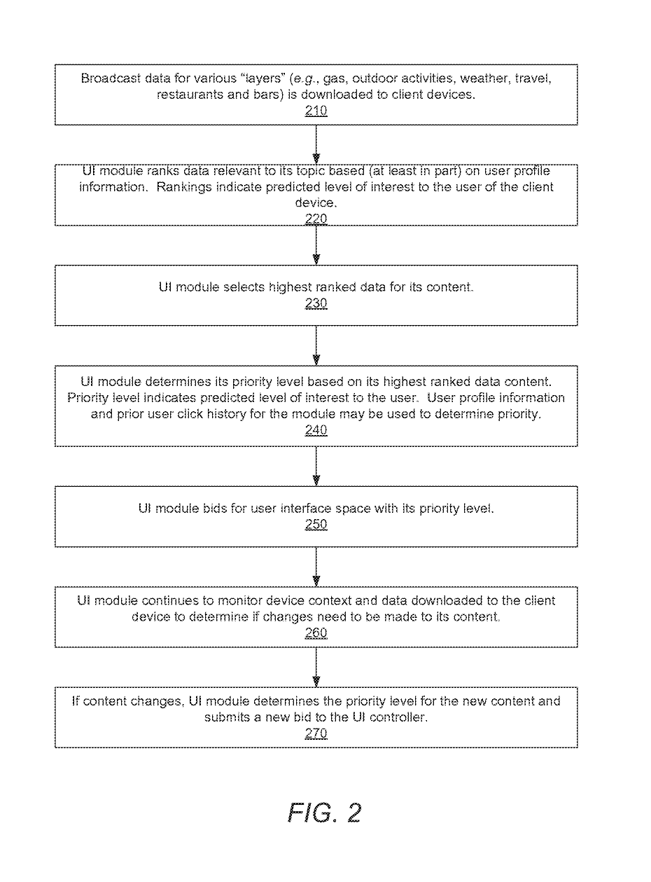

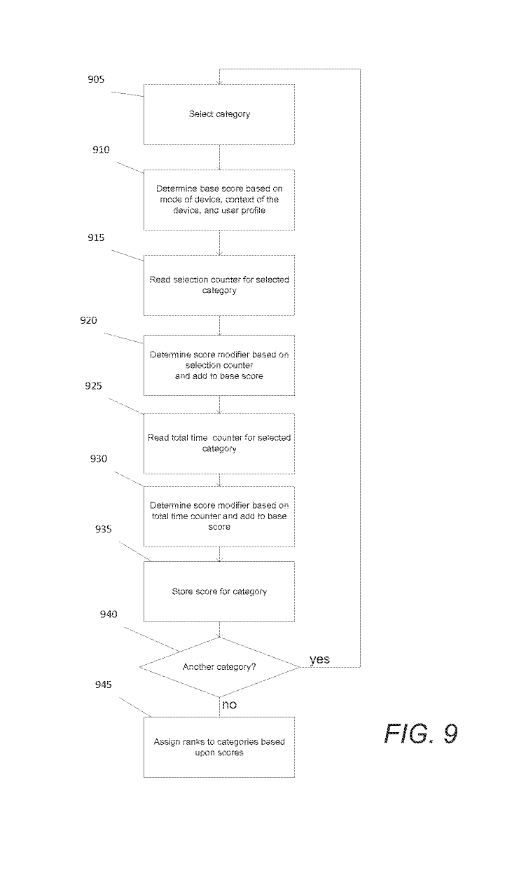

FIG. 2 describes the operation of a UI module in accordance with embodiments of this invention. Initially, the broadcast data for various “layers” (e.g., gas, outdoor activities, shopping, weather, travel, restaurants and bars) is downloaded to the client devices (210). A layer is a collection of categories. For example, one layer may be “restaurants and pubs” that includes “categories” for each particular restaurant or pub in an area. Each category includes the content for the particular restaurant or pub. Another layer may be “outdoors” that includes categories for each particular outdoor activity in the area. The categories include the content for each outdoor activity. Also, data specific to a user, such as data from social websites (e.g., FACEBOOK) may be downloaded to the client device. Each UI module determines the categories in each layer that are relevant to the information that module provides and then ranks the determined categories (220). For many UI modules, the rankings of the categories are based (at least in part) on user profile information. A process for determining rankings of categories in accordance with an embodiment of this invention is described below with reference to FIG. 9. The User profile information that may be used to rank the categories may include the user's preferences, past behavior, places the user has been, content on which the user has clicked or selected, input information indicating user's preferences, activities on social websites (e.g., FACEBOOK), and much more. Rankings also may be based on the current context of the device that includes information such as, location, whether driving, etc. The ranking of each category indicates a predicted level of interest for the content of the category to the user of the client device.

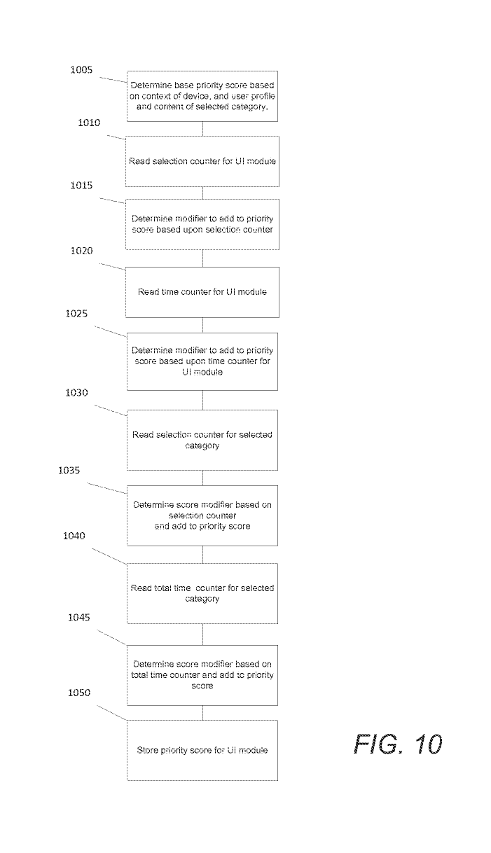

The UI module then selects the highest ranked category to use for display content (230). Based upon the selected category, the UI module determines a priority level (240). In accordance with some embodiments of this invention, the determination of the priority level usually is based upon account user profile information and prior user click history. In accordance with some other embodiments, the UI module also may take into account the context of the client device in determining its priority level. A process for determining the priority performed by a UI module in accordance with an embodiment of this invention is described below with reference to FIG. 10. The UI module then bids for a user interface space in the user interface display with its priority level by providing its priority level to the UI controller (250). In one embodiment, the priority level is provided in a numeric range of 1-100, with 1 being the lowest priority and 100 being the highest priority. In other embodiments, any of a variety of priority ranking systems can be utilized to indicate the priority of a specific UI module to a UI controller.

Regardless of whether a particular UI module is selected for display in the user interface by the UI controller, the UI module continues to monitor the client device's context and data downloaded to the client device to determine if changes need to be made to categories provided by the UI module (260). In accordance with embodiments of this invention, the device context may include the GPS location of the client device, the operating mode of the client device, the type of network over which the device is communicating, the power usage of the device, and any other information about the client device. If the UI module determines that a new category contains more relevant information and should be displayed, then the UI module can determine a new priority level for the new category of content and submit a new bid with the new priority level to the UI controller (270).

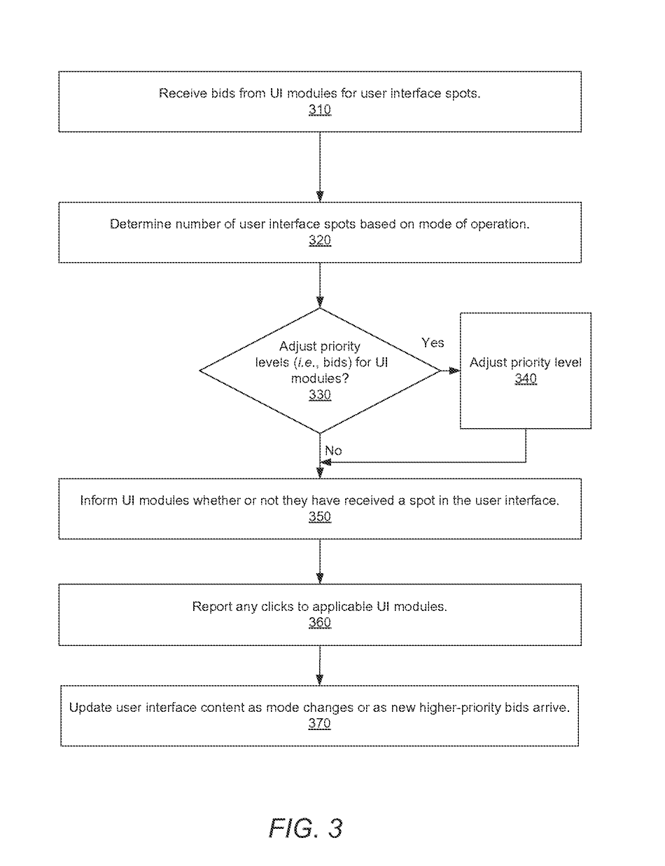

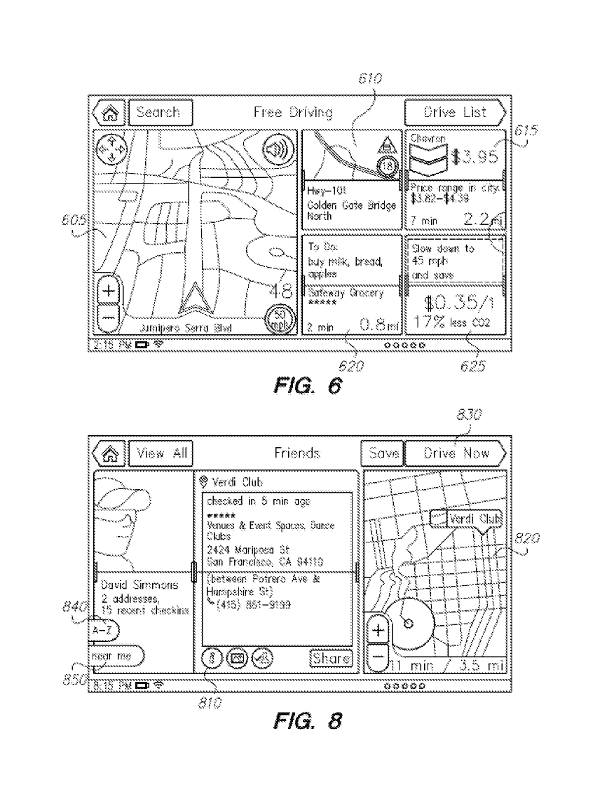

An auction process for assigning user interface spaces in the user interface display to the UI modules performed by the UI controller in accordance with embodiments of this invention is shown in FIG. 3. The UI controller receives bids from the UI modules for user interface spots (310). The UI controller then determines the number of user interface spots available to the UI modules in the user interface display based on the mode of operation of the user interface (320). Different modes of the user interface for a navigation device in accordance with embodiments of the invention are illustrated in FIGS. 5A, 5B, and 6. Different types of devices will likely have different types of modes for the user interface as appropriate to the requirements of a specific application in accordance with embodiments of the invention. Each mode may have any number of configurations capable of displaying any number of UI modules. Based upon the mode, the UI controller determines the number of UI modules that will be selected to display information within the user interface.

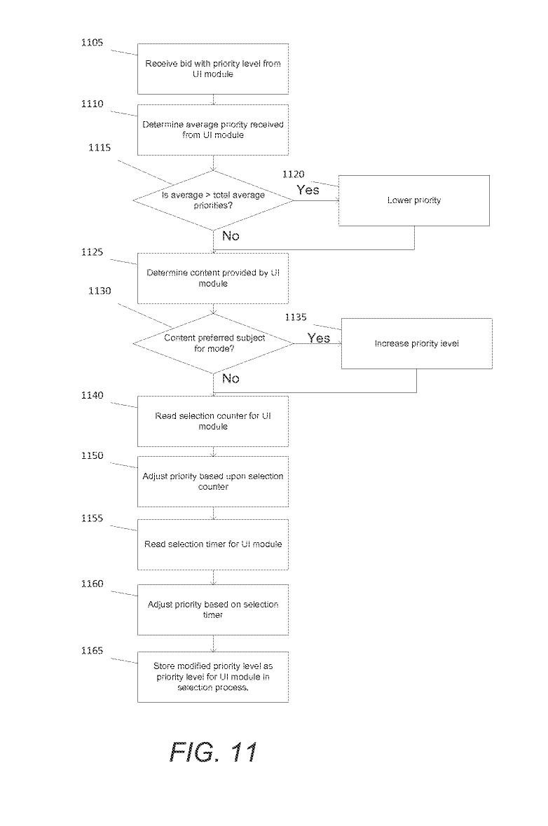

The UI controller has the option of adjusting the priority level, or bids, for each UI module (330). This may be necessary in cases where there is an open platform for UI modules and many different people/entities may create UI modules. In such case, how each UI module determines the value for its priority may vary greatly, and the UI Controller may be configured to adjust priority levels if it finds certain modules tend to consistently bid too high or too low relative to the actual interest of a user as determined based upon user interactions with the information displayed via the user interface. In certain embodiments, upgrading or downgrading a UI module's priority is based on the type of information the UI module displays, where certain categories or modules will always have a higher priority than others. For example, if the Deals module submits a bid with a high priority, but the Traffic and Road Alerts module has an alert regarding an upcoming road accident, the UI controller may adjust the priority levels such that the Traffic and Road Alerts module has a higher priority than the Deals module (340). A process for adjusting the priority level received from a UI in accordance with embodiments of this invention is described below with reference to FIG. 11.

The UI controller informs each of the UI modules whether or not the module has received a spot in the user interface (350). The UI controller also reports any clicks or selections received via the user interface to the applicable UI modules that are displayed so that the UI modules can take into account the clicks (selections) or lack of clicks (selections) in determining future priority (360). The UI controller can then update the user interface content as the mode changes (and hence the number of available user interface spots changes) or as new higher priority bids arrive from UI modules (370). In accordance with some embodiments, the UI controller monitors the bids from the UI modules continuously. In accordance with other embodiments, the UI controller periodically polls for new bids from the UI modules.

In accordance with many embodiments, if the UI controller receives a higher-than-average bid from a UI module, it may display the content of the UI module in the user interface along with an alert to bring attention to the content of the UI module. For example, the applicable content of the UI module may be backlit in the user interface.

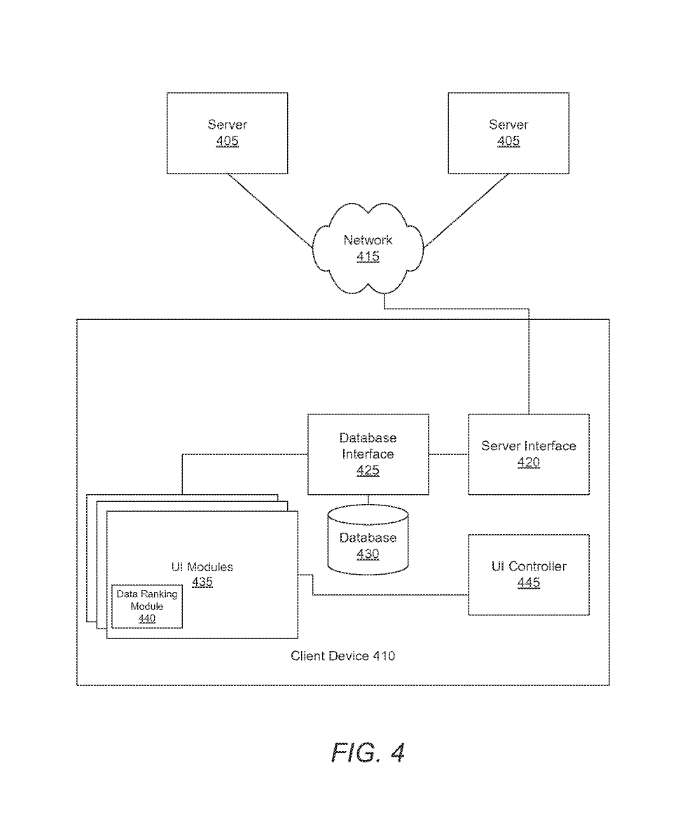

FIG. 4 illustrates the devices in a network that communicate to provide a system in accordance with this invention and a software architecture of a client device configured to perform methods in accordance with embodiments of this invention. As a person skilled in the art would understand, any number of software architectures may be used as appropriate the requirements of a specific application in accordance with embodiments of the invention. In FIG. 4, one or more servers 405 are connected to a client device 410 via a network 415. In accordance with one embodiment, the servers 405 download broadcast data in various categories to the client devices. Examples of the servers include, but are not limited to, transit servers, reader servers, and hybrid servers. The client device 410 has a server interface 420 for interfacing between the client device and the one or more servers 405. The server interface 420 is connected to a database interface 425 and a database 430, which stores user profile information and past user history, among other data. Database 430 also temporarily stores data downloaded to client devices. The database interface 425 is connected to UI modules 435, where each of the UI modules has a data-ranking module 440. As described in FIG. 2, the data ranking module 440 ranks categories of data downloaded to the client device 410 that are relevant to the topic of the content provided by a particular UI module. The UI modules 435 are connected to a UI controller 445. In one embodiment, the UI modules 435 and UI controller 445 operate as discussed with respect to FIGS. 2 and 3. A person skilled in the art would understand that the computer system may also have a memory or other physical storage medium for storing software instructions and one or more processors for executing the software instructions that provide and perform the above described software architecture.

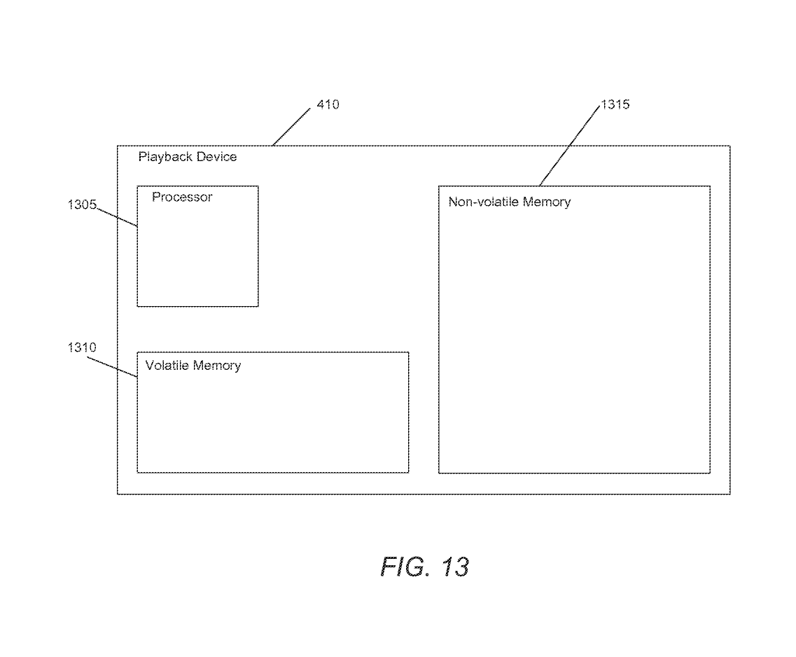

The relevant components in a client device 410 that perform processes similar to those described above in accordance with an embodiment of the invention are shown in FIG. 13. One skilled in the art will recognize that the client device may include other components that are omitted for brevity without departing from this invention. The client device 410 includes a processor 1305, a non-volatile memory 1310, and a volatile memory 1315. The processor 1305 is a processor, microprocessor, controller, or a combination of processors, microprocessor, and/or controllers that performs instructions stored in the volatile 1315 or non-volatile memory 1310 to manipulate data stored in the memory. The non-volatile memory 1310 can store the processor instructions utilized to configure the client device 410 to perform processes including processes in accordance with embodiments of the invention and/or data for the processes being utilized. In other embodiments, the client device software and/or firmware can be stored in any of a variety of non-transient computer readable media appropriate to a specific application. Although a client device 410 is illustrated in FIG. 13, any of a variety of client devices configured to provide the methods and systems in accordance with embodiments of the invention can be utilized.

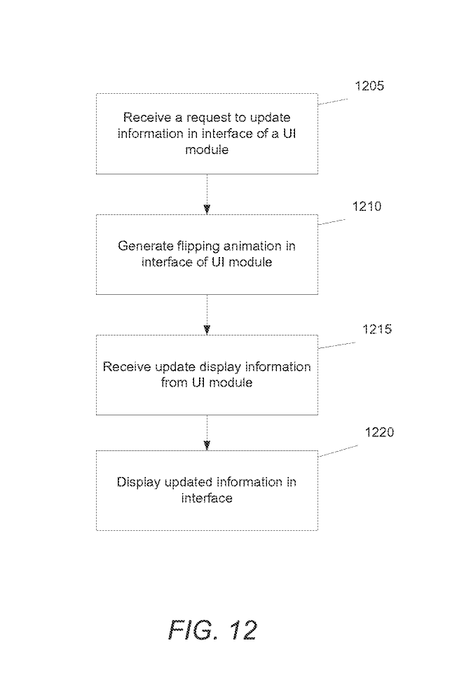

FIGS. 5A and 5B illustrate user interfaces of a navigation device in accordance with embodiments of this invention. FIG. 5A illustrates a “dashboard” view in which five interface spots display content from UI modules, where the interface spot for the content of one UI module, the map 505, is larger than the interface spots to display the content of the other four modules and highlights the locations of the presented content from the other four modules relative to the user. The other four modules displaying content are a “Weather” module 510 that provides weather information, the “Gas Price” module 515, the Friends module 520, and the Deals module 525. Each displayed module, such as “Gas Price” module 515, is split into two halves 516 and 517 substantially horizontally. When the information being displayed for the category changes, a flipping animation is performed. The flipping animation makes halves 516 and 517 appear to be rotating to display the new information. The new information may be additional information about the displayed category or may indicate the category being displayed by the UI module has changed. A process for performing the flipping animation is described below with reference to FIG. 12. FIG. 5B illustrates another “dashboard” configuration, having eight interface spots that display content from UI modules. The interface spots display contents from the Weather module 510; the Gas Price module 515; the Friends module 520; the Deals module 525; the Spaces module 530; the Traffic and Road Alerts module 535; a Yelp module 540; and an Eco Driving module 545. From either of the interfaces shown in FIGS. 5A and 5B, the user can click on a Search button 550 or add a particular destination represented by one of the modules to the user's Drive List 555. In one embodiment, the dashboard view is used when the device is in a handheld or on-desk mode.

FIG. 6 illustrates a user interface for a navigation device in a “Driving” mode. Similar to FIGS. 5A and 5B, FIG. 6 has five interface spots to display content from five UI modules, where one interface spot for displaying content from an UI module, the map 605, is larger than the other interface spots for the content from the other four modules and illustrates the path that the user is taking. The map module 605 may provide audio, as well as visual interactivity. There may be the option for zooming in or out; and/or providing related information, such as the user's speed along the highway. The other four modules displaying content in the remaining interface spots are the Traffic and Road Alerts module 610, the Gas Prices module 615, the To Do List module 620, and the Eco Driving module 625, all of which provide the user with information related to his or her drive.

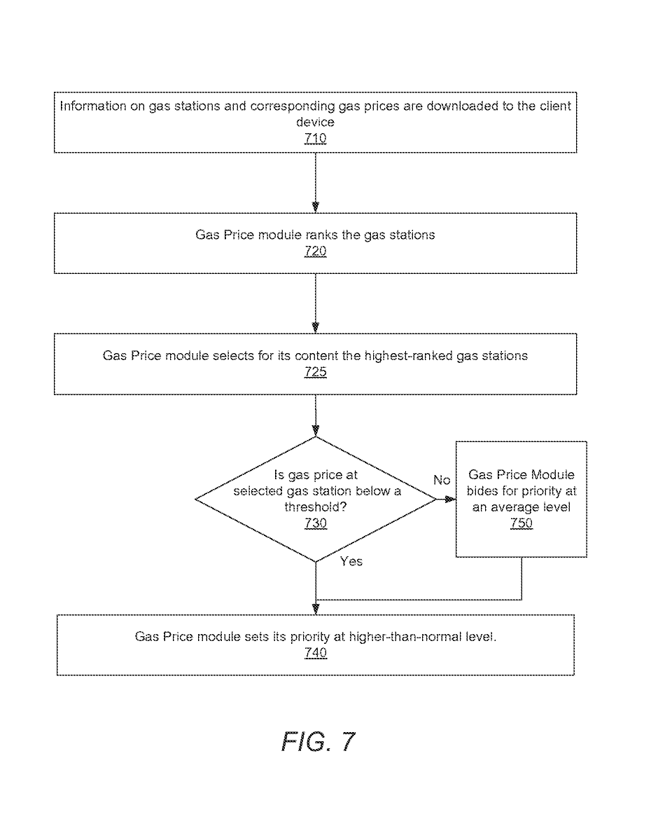

As seen in FIGS. 5A, 5B, and 6, the user interfaces may have any number of interface spots for displaying content from UI modules, each of which operate independently according to their own software model. As two representative examples, FIG. 7 illustrates a “Gas Price” module in accordance with an embodiment of this invention, and FIG. 8 illustrates a “Friends” module in accordance with embodiments of this invention.

Turning now to FIG. 7, the operation of a UI module that displays gas prices for a navigation device/application in accordance with an embodiment of this invention is described. Categories that include data for gas stations and corresponding gas prices are downloaded to the client device (710). The Gas Price module examines each category for gas stations that are currently near the user or, if the user is driving, will be near the user in the near future (720). The Gas Price module then ranks the categories for the gas stations, taking into account the gas price, the user's location, proximity to freeway exits (if applicable), user preferences, and any other applicable factors. The Gas Price module selects the highest-rank gas station category for the displayed content (725). The Gas Price Module then determines if the price at the selected gas station is below a threshold (730). The threshold may be based on historical averages, gas prices at gas stations that a user frequents, and/or gas prices in the categories ranked by the UI module. If the price is below the threshold, the Gas Price module sets its priority (i.e., its bid for UI space) at a higher-than-normal (for the Gas Price Module) level (740). Otherwise, the Gas Price Module bids for priority at what is an “average” or “medium” level for the Gas Price module (750).

The Friends module provides content about the places that friends of a user have “checked in” both in the past and at present. For example, if one friend checked in to a local restaurant on Four Square and another friend checked in to the same restaurant on Facebook, the Friends module would disambiguate the difference between the social media programs and display to the user that two friends are currently checked in to the restaurant, which may be of some interest to the user who may want to navigate to that location. While two friends at the same location may be of medium interest, if two friends are currently checked in and the user has visited the location several times previously, the Friends module may assign the data a higher priority because of the increase in interest level. If, however, two friends are currently checked in, the user has visited the location several times previously, and a coupon is available for the location, then the Friends module may assign the data the highest priority in submitting a bid to the UI controller.

In accordance with one embodiment, there is a “home” mode and an “active” mode for the UI modules. In the home mode, the UI modules display high-level, summary content. In the “active” mode, this is displayed when a user clicks (i.e., selects) content from a UI module, more detailed information is displayed about the content on which the user clicked. FIG. 8 illustrates a display provided for the “active” mode by a Friends module. In this example, the user had clicked on Friend module 520 in FIG. 5A to obtain more content about the displayed content which is one of the user's friends, David Simmons. In the active mode, the Friends module provides a display in window 810 that is includes content about the Verdi Club into which Mr. Simmons has checked in. In addition, the active mode of the Friends module provides on a map 820 the route between the user's current location and the Verdi Club. By pressing the Drive Now button 830, the user interface can provide the user with turn-by-turn instructions of how to navigate to the Verdi Club. If, however, the user would like to look up information about or the location of another friend, the user can scroll through his or her contact list, by pressing the A-Z button 840 or search for friends in the immediate vicinity by pressing the Near Me button 850.

As discussed above with respect to FIG. 2, a process that a UI module can use to rank the “categories” of information within the “layers” of information downloaded to a client device in accordance with an embodiment of this invention is illustrated in FIG. 9. The illustrated process determines a score for each category of downloaded content and then ranks the categories based upon the determined scores. As noted above, the categories are typically categories of information within layers of information downloaded by the client device. The scores for each category may be determined based upon the mode of the device, the context of the device, the user profile, the number of times a category has previously been selected for viewing, and the amount of time spent viewing the category when the category is selected. It is envisioned that any number of processes may be used to rank the categories by a UI module and the process shown in FIG. 9 only shows some of the data that may be used to rank categories. However, it is envisioned that each UI module will use the number of times a category has been selected for viewing and the amount of time the category is viewed in determining the ranking for the content within the UI module to provide the user with content the user desires to view. Furthermore, it is further envisioned that the number of times the category is selected will be weighted greater than the amount of time spent viewing.

The ranking process illustrated in FIG. 9 begins by selecting one of the categories downloaded (905). The process determines a base score based upon the mode of the device, the context of the device, and the user profile (910). This base score may be the same for each category. Alternatively, the base score may be scaled based upon the relatedness of the categories to certain information in these fields. For example, categories may be assigned different scores based on the proximity of the content of the category to the location of the device.

The selection counter of the category is read (915). A selection counter is a stored count of the number of times the category has previously been selected when displayed by the UI. This may be read from a database record for the category or stored independently by the UI. The selection counter is then used to determine a score modifier that is added to the base score (920) or otherwise used to modify the base score. The score modifier may either increase or decrease the base score. In accordance with the process illustrated in FIG. 9, the selection counter is determined to be in a certain range and a modifier associated with the range is selected. For example, the ranges may include ranges of 0-50, 50-100, 100-1000, and 1000+. Each of these ranges has an associated modifier such as the 0-50 range is associated with a +5 modifier, the 50-100 range is associated with a +10 modifier, the 100-1000 range is associated with a +20 modifier and the 1000+ range is associated with a +50 modifier. In other embodiments, any of a variety of modifiers can be utilized as appropriate to the requirements of a specific application.

The total counter of the category is also read (925). A total counter is a stored count of the total amount of time the category has previously been viewed when displayed by the UI. The total time counter may be read from a database record for the category or stored independently by the UI. The total counter is then used to determine a score modifier that is added to the base score (930). The score modifier may either increase or decrease the base score. In accordance with the process illustrated in FIG. 9, the total time counter is determined to be in a certain range and a modifier associated with the range is selected. For example, the ranges may include ranges of 0-60 seconds, 60-600 seconds, 600-6000, and 6000+ seconds. Each of these ranges has an associated modifier such as the 0-60 seconds range is associated with a +2 modifier, the 60-600 seconds range is associated with a +5 modifier, the 600-6000 seconds range is associated with a +10 modifier and the 6000+ seconds range is associated with a +25 modifier. As can be seen from the examples, the ranges for the total time are given lesser values than the ranges of the selection counter to cause the selection counter to provide more weight in the determination of the score. However, other manners of weighting and modifying the scores with the counters can be used.

The score with the added modifiers is stored (935). The process then determines if other categories have been downloaded (940). If so, the process is repeated until a score is determined in each category. The scores of each of the categories is then compared and the categories are ranked based on the scores (950). In the described process, the categories are ranked from highest to lowest score. However, other ranking schemes may be used.

As discussed above, a process performed by a UI module to determine the priority of the UI module in accordance with an embodiment of this invention is illustrated in FIG. 10. The illustrated process determines the priority score that is used by the UI module in the bidding process. The priority of the UI module may be determined based upon the mode of the device, the context of the device, the user profile, the number of times a UI module and the category displayed by the UI module has previously been selected for viewing, and the amount of time spent viewing the UI module and the category being displayed by the module when the module is selected. It is envisioned that any number of processes may be used to determine the priority of a UI module and the process shown in FIG. 10 only shows some of the data that may be used to determine the priority of the module. However, it is envisioned that each user module will use the number of times a module and the displayed category have been selected for viewing and the amount of time the UI and the selected category have been viewed to determine the priority relate the priority of the module to the viewing habits of the user. Furthermore, it is further envisioned that the number of times the UI module and/or category have selected will be weighted greater than the amount of time spent viewing the module and/or category. Although, in any other embodiments, any of a variety of techniques for weighting and/or modifying the priority of a UI module and/or category can be utilized as a appropriate to the requirements of a specific application.

The priority determining process illustrated in FIG. 10 begins by determining a base score based upon the mode of the device, the context of the device, the user profile and the category selected by the UI module for display (1005). This base score may be the same for each category. Alternatively, the base score may be scaled based upon the relatedness of the UI module to certain information in the other parameters. For example, The UI module displaying content relating to gasoline stations may select a greater base priority score when the device is in a “driving mode” as opposed to when the device is in a “desktop mode” as the information of the module is more important to the user in the “driving mode” than in the “desktop mode.”

The selection counter of the UI module is read (1010). A selection counter is a stored count of the number of times the category has previously been selected when the UI module has been displayed. This may be read from a database record for the UI module or stored independently by the UI module. The selection counter for the UI module is then used to determine a score modifier that is added to the base priority score (1015). The score modifier may either increase or decrease the base priority score. In accordance with the process illustrated in FIG. 10, the selection counter for the UI module is determined to be in a certain range and a modifier associated with the range is selected. For example, the ranges may include ranges of 0-50, 50-100, 100-1000, and 1000+. Each of these ranges has an associated modifier such as the 0-50 range is associated with a +5 modifier, the 50-100 range is associated with a +10 modifier, the 100-1000 range is associated with a +20 modifier and the 1000+ range is associated with a +50 modifier. As noted above, any of a variety of linear and/or non-linear modifiers can be utilized as appropriate to the requirements of specific UI modules, categories, and/or applications in accordance with embodiments of the invention.

The total counter of the UI module is also read (1020). A total counter is a stored count of the total amount of time the UI module has previously been viewed when displayed. The total time counter of the UI module may be read from a database record for the UI module or stored independently by the UI module. The total time counter for the UI module is then used to determine a score modifier that is added to the base score (1025). The score modifier may either increase or decrease the base score. In accordance with the process illustrated in FIG. 10, the total time counter is determined to be in a certain range and a modifier associated with the range is selected. For example, the ranges may include ranges of 0-60 seconds, 60-600 seconds, 600-6000, and 6000+ seconds. Each of these ranges has an associated modifier such as the 0-60 seconds range is associated with a +2 modifier, the 60-600 seconds range is associated with a +5 modifier, the 600-6000 seconds range is associated with a +10 modifier and the 6000+ seconds range is associated with a +25 modifier. As can be seen from the examples, the ranges for the total time are given lesser values than the ranges of the selection counter to cause the selection counter to provide more weight in the determination of the score. However, other manners of weighting and modifying the scores with the counters can be used.

The selection counter of the category to be displayed by the UI module is read (1030). A selection counter for the category is a stored count of the number of times the category has previously been selected when displayed by the UI module. This may be read from a database record for the category or stored independently by the UI module. The selection counter for the category is then used to determine a score modifier that is added to the base score (1035). The score modifier may either increase or decrease the base score. In accordance with the process illustrated in FIG. 10, the selection counter for the category is determined to be in a certain range and a modifier associated with the range is selected. For example, the ranges may include ranges of 0-50, 50-100, 100-1000, and 1000+. Each of these ranges has an associated modifier such as the 0-50 range is associated with a +2 modifier, the 50-100 range is associated with a +3 modifier, the 100-1000 range is associated with a +5 modifier and the 1000+ range is associated with a +7 modifier. In the described process, the score modifiers for selection count for the category are less than the selection count of the UI module as the importance of number of times the category has been selected is less important than the number of times the UI module has been selected for the purpose of determining the priority of the UI module.

The total time counter of the selected category is also read (1040). A total time counter of the category is a stored count of the total amount of time the category has previously been viewed when displayed based upon a selection of the category when the category is displayed by the UI. The total time counter of the category may be read from a database record for the category or stored independently by the UI module. The total time counter of the category is then used to determine the score modifier that is added to the base score (1045). The score modifier may either increase or decrease the base score. In accordance with the process illustrated in FIG. 10, the total time counter of the category is determined to be in a certain range and a modifier associated with the range is selected. For example, the ranges may include ranges of 0-60 seconds, 60-600 seconds, 600-6000, and 6000+ seconds. Each of these ranges has an associated modifier such as the 0-60 seconds range is associated with a +1 modifier, the 60-600 seconds range is associated with a +2 modifier, the 600-6000 seconds range is associated with a +3 modifier and the 6000+ seconds range is associated with a +10 modifier. As can be seen from the examples, The modifiers for the total time of the category in the priority process are less than the modifiers of the total time for the display of the UI module to reflect that the total time that the category is viewed is less important than the total time the UI module has been viewed for the purposes of determining priority. Further, the ranges for the total time of the category are given lesser values than the ranges of the selection counter of the category to cause the selection counter to be provided with more weight in the determination of the priority score. However, other manners of weighting and modifying the scores with the counters can be used as appropriate to the requirements of a specific application in accordance with an embodiment of the invention. After all of the modifiers have been added, the priority score is stored (1050) and is used to generate the transmitted bid.

A process performed by the UI controller for modifying a priority level of an UI module received in a bid from a UI module in accordance with an embodiment of this invention is illustrated in FIG. 11. The process modifies the priority levels received from UI modules to increase the likelihood that the UI modules provide useful content to a user as well as to prevent a UI module that may not include useful or desired content from being selected because it supplies bids containing inflated priority levels.

A bid from a UI module is received and the priority level of the UI module is read (1105). The UI controller then determines the average priority level received in the bids by the UI (1110). This may be done by reading bids previously received from a memory or by reading the average itself from the memory. The memory may be maintained by the UI controller or the database depending on the embodiment of the invention. The average priority received from the bids is then compared to the total average of the priority levels received in all bids that is maintained by the UI controller (1115). If the average of the particular UI is greater than the average of the total priorities received, the UI controller subtracts the difference between the average of the UI module and the total priority average from the priority level received in the bid (1120).

The UI controller also determines the content provided by the UI module (1125). The UI controller then determines whether the content provided by the UI module is desired or preferred content with respect to a specific mode of the device. If the content is desirable, the priority level of the UI module is increased. For example in the “driving mode” the gas price UI module may be considered desired content that should be displayed. To assure that the gas price UI module is displayed, the UI controller can set the priority level to 100 on a scale of 1-100 to increase the likelihood that the UI module will be selected for display. One skilled in the art will recognize that the exact increase of the priority level is a design choice and should just be set to an appropriate level to result in the selection of the particular UI module for display.

The process may also want to modify the bids to account for user preferences. In the illustrated embodiment, the process of modifying the bids in response to user preferences can involve the UI controller recalculating the priority score using the same pieces of information utilized by the UI module to determine its initial priority bid and/or different pieces of information and adjusting the priority of the UI module according to the revised calculation. In the illustrated embodiment the initial bid is modified in response to user preferences based upon the selection and time viewed counters of the UI module. The selection counter of the UI module is read (1140). A selection counter is a stored count of the number of times the category has previously been selected when the UI module has been displayed. This may be read from a database record for the UI module or stored independently by the UI controller. The selection counter for the UI module is then used to adjust the priority level of the UI module (1150). The adjustment may either increase or decrease the base priority score. In accordance with the process illustrated in FIG. 11, the selection counter for the UI module is determined to be in a certain range and a modifier associated with the range is added to the priority level. For example, the ranges may include ranges of 0-50, 50-100, 100-1000, and 1000+. Each of these ranges has an associated modifier such as the 0-50 range is associated with a +5 modifier, the 50-100 range is associated with a +10 modifier, the 100-1000 range is associated with a +20 modifier and the 1000+ range is associated with a +50 modifier. The modifier is then added to the priority level. As can be readily appreciated, any of a variety of linear or non-linear modifiers can be applied to the priority level as appropriate to the requirements of a specific application in accordance with an embodiment of the invention.

The total time viewed counter of the UI module is also read (1155). A total time viewed counter is a stored count of the total amount of time the UI module has previously been viewed when displayed. The total time counter of the UI module may be read from a database record for the UI module or stored independently by the UI controller. The total time counter for the UI module is then used to determine a score modifier that is added to the priority level (1160). The score modifier may either increase or decrease the base score. In accordance with the process illustrated in FIG. 11, the total time counter is determined to be in a certain range and a modifier associated with the range is selected. For example, the ranges may include ranges of 0-60 seconds, 60-600 seconds, 600-6000, and 6000+ seconds. Each of these ranges has an associated modifier such as the 0-60 seconds range is associated with a +2 modifier, the 60-600 seconds range is associated with a +5 modifier, the 600-6000 seconds range is associated with a +10 modifier and the 6000+ seconds range is associated with a +25 modifier. As can be seen from the examples, the ranges for the total time are given lesser values than the ranges of the selection counter to cause the selection counter to provide more weight in the determination of the score. However, other manners of weighting and modifying the scores with the counters can be used. The priority level as modified by the process is then stored for use in the selection process (1165). Although the processes discussed above with reference to FIG. 11 utilize UI module selections and the time that the UI module is viewed to adjust the priority of a UI module based on user preferences, any of a variety of pieces of information and/or techniques can be utilized to adjust the priority of a UI module in response to user preferences as appropriate to the requirements of a specific application in accordance with embodiments of the invention.

A flipping animation can be used to indicate that the information a UI module is displaying in an interface has changed. The change may be in response to a request for additional information by a user or may be to update the category information being displayed. A process performed by a UI controller for providing a flipping animation in accordance with an embodiment of this invention is shown in FIG. 12. In the process, the UI controller receives a request to update the information being displayed by a UI module via the UI interface. The updated information may be information that is satisfying a request received from a user via the user interface for more information, information for a new category to be displayed by the UI module, or any other type of change to the information being displayed by the UI module. The UI processor generates a flipping animation and displays the flipping animation in the interface of the UI module that sent the request (1210). The updated information is then displayed in the interface of the UI module after the flipping animation is completed (1215). The flipping animation may have the appearance of a rolling or flipping of half tiles. In other embodiments, any of a variety of animations can be utilized to transition from one piece of visual information to another piece of information within a UI module in accordance with an embodiment of the invention.

Although examples of the invention have been described with respect to navigation devices, the invention is not limited to navigation devices or applications. The invention may be used to generate user interfaces for various types of application and on various types of devices.

As will be understood by those familiar with the art, the invention may be embodied in other specific forms without departing from the spirit or essential characteristics thereof. Accordingly, the above disclosure of the present invention is intended to be illustrative and not limiting of the invention.

What is claimed is:

1. A method for displaying a user interface (UI) including a plurality of regions for displaying content on a computing device, wherein the UI comprises a plurality of UI modules being executed by the computing device that select content for display within a region of the user interface and a UI controller being executed by the computer device that selects at least one UI module to provide content for display within each of the plurality of regions in the UI, the method comprising:
receiving information for each of a plurality of categories of content using the computing device;
ranking the plurality of categories using each of the plurality of UI modules;
selecting one of the categories to display in each UI module;
determining a priority level in each UI module;
transmitting a bid from each UI module to the UI controller wherein the bid includes the priority level of the UI module;
receiving the bid from each UI module in the UI controller; and
assigning at least one UI module to display content in each of the plurality of regions of the user interface based on the priority levels of the UI modules using the UI controller.

2. The method of claim 1, further comprising:
determining whether the priority level of a UI module is acceptable by the UI controller based upon predefined criteria; and
adjusting the priority level of a UI module by the UI controller in response to the priority level not being acceptable.

3. The method of claim 2 wherein the adjusting of the priority level of a UI module by the UI controller comprises:
determining an average priority level value received in bides from the UI module;
comparing the average priority level of the UI module to a threshold value; and
modifying the priority level of the UI module based upon the comparison to the threshold value.

4. The method of claim 2 wherein the adjusting of the priority level of a UI module by the UI controller comprises:
determining whether content provided by the UI module is preferred content for a current mode of the device; and
adjusting the priority level based upon the determination as to whether the content is preferred content.

5. The method of claim 2 wherein the adjusting of the priority level of the UI module by the UI controller comprises:
determining a number of time the UI module has been selected for viewing by a user; and
adjusting the priority level of the UI module based upon the number of selections of the UI module.

6. The method of claim 2 wherein the adjusting of the priority level of the UI module by the UI controller comprises:
determining a total amount of time the UI module has been viewed when selected for viewing by a user; and
adjusting the priority level of the UI module based upon the total amount of time the UI module has been viewed.

7. A device for displaying a user interface (UI) including a plurality of regions for displaying content on a computing device, wherein the UI comprises a plurality of UI modules being executed by the device that select content for display within a region of the user interface and a UI controller being executed by the device that selects at least one UI module to provide content for display within each of the plurality of regions in the UI comprising:
a memory; and
a processor configured via one or more applications stored in the memory to:
receive information for each of a plurality of categories of content using the computing device,
rank the plurality of categories using each of the plurality of UI modules;
select one of the categories to display in each UI module,
determine a priority level in each UI module,
transmit a bid from each UI module to the UI controller wherein the bid includes the priority level of the UI module,
receive the bid from each UI module in the UI controller, and
assign at least one UI module to display content in each of the plurality of regions of the user interface based on the priority levels of the UI modules using the UI controller.

8. The device of claim 7 wherein the processor is further configured to:
determine whether the priority level of a UI module is acceptable by the UI controller based upon predefined criteria, and
adjust the priority level of a UI module by the UI controller in response to the priority level not being acceptable.

9. A machine readable medium containing processor instructions, where execution of the instructions by a processor causes the processor to perform a process for displaying a user interface (UI) including a plurality of regions for displaying content on a computing device, wherein the UI comprises a plurality of UI modules being executed by the device that select content for display within a region of the user interface and a UI controller being executed by the device that selects at least one UI module to provide content for display within each of the plurality of regions in the UI, the process comprising:
receiving information for each of a plurality of categories of content using the computing device;
ranking the plurality of categories using each of the plurality of UI modules;
selecting one of the categories to display in each UI module;
determining a priority level in each UI module;
transmitting a bid from each UI module to the UI controller wherein the bid includes the priority level of the UI module;
receiving the bid from each UI module in the UI controller; and
assigning at least one UI module to display content in each of the plurality of regions of the user interface based on the priority levels of the UI modules using the UI controller.

10. The machine readable medium of claim 9 wherein the process further comprises:
determining whether the priority level of a UI module is acceptable by the UI controller based upon predefined criteria; and
adjusting the priority level of a UI module by the UI controller in response to the priority level not being acceptable.

11. A method for indicating a change in content in a region of a user interface (UI) of a computing device displaying content of a UI module being executed by the computing device, wherein the display in the region is divided into a first half and a second half by a solid bar displayed as dissecting the region, the method comprising:
receiving a request in the UI controller to update content being displayed in a region from the UI module providing the content to display in the region;
receiving updated content from the UI module providing content in the region at the UI controller;
generating a flip animation in the UI controller to display in the region that causes content in the first half of the region to appear to fold over content in the second half of the region;
displaying the flip animation in the region in the user interface of the computing device; and
displaying the updated content in the region in the user interface of the computing device.
